(19) United States
(12) Patent Application Publication
(10) Pub. No.: US 2002/0094860 A1
(43) Pub. Date: Jul. 18, 2002

(54) Fully automated bingo session

(76) Inventors: Yuri Itkis, Las Vegas, NV (US); Boris Itkis, Las Vegas, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/042,004

(22) Filed: Oct. 19, 2001

Related U.S. Application Data
(60) Provisional application No. 60/241,982, filed on Oct. 19, 2000.

(51) Int. Cl. G06F 19/00

(52) U.S. Cl. 463/19

(57) ABSTRACT

Players obtain computer-generated barcoded sales receipts that identify bingo cards the player is to play during a bingo session. The receipts are sold at point-of-sale terminals interconnected to a bingo caller terminal that acts as a file server maintaining a database of all sold bingo cards. The server randomly generates bingo numbers, verifies all cards each time a new number is called and ends the current game when at least one winning card is detected. The bingo caller terminal computes all prizes and maintains databases of the identification numbers of winning cards and corresponding receipts, the prizes paid and the outstanding payout liabilities. The bingo caller terminal initiates a new game upon completion of the current game. Players check the status of their cards by scanning their receipts at self-service terminals upon a game's completion. Players collect winnings at cashier point of sale terminals upon submitting receipts and player-tracking cards.

### CROSS REFERENCE TO RELATED APPLICATIONS

This application claims the benefit of U.S. Provisional Application No. 60/241,982, filed Oct. 19, 2000.

### FIELD OF THE INVENTION

The invention is related to the field of automated systems for playing a game of bingo, especially as applicable to playing bingo in a casino environment.

### BACKGROUND OF THE INVENTION

Bingo game is one of the most popular games frequently played in charity bingo halls and casinos. While bingo is the main source of revenues for charity bingo halls, it is only a marketing tool for casinos wherein it serves the purpose of attracting players to casino in expectation that players will also play highly profitable slot machines and table games. Casinos typically run hour-long bingo sessions every other hour to facilitate playing of slots and tables between bingo sessions. A relatively high cost of operating a bingo hall and relatively low revenues typically generated by the bingo hall in a casino environment, preclude a majority of casinos from offering bingo to their patrons.

A number of attempts to develop a low-cost, high-revenue bingo game that may conceivably be applicable to a casino environment have been made. In particular, U.S. Pat. Nos. 4,909,516 to Kolinsky and 5,951,396 to Tawil disclose automated bingo games that utilize computers to continuously check all playing bingo cards for matches with called bingo numbers and bingo patterns being played. While Kolinsky's and Tawil's central computers automatically verify all bingo cards every time a new bingo number is called, players still monitor called bingo numbers on TV screens and manually mark (“daub”) their conventional paper bingo cards. To “cash-out”a winning paper bingo card, a player surrenders it to a cashier who enters the card “face number”, or preferably scans barcode imprinted on the card, into a computer system to validate the winning card. Although Kolinsky and Tawil disclose automatic verification of sold bingo cards without player involvement, their teachings are not applicable in a casino environment for a number of reasons routed in the reliance on cumbersome paper bingo cards. In particular, the paper bingo cards are bulky, inconvenient to play on slot machine tops, messy, create a garbage disposal problem and most importantly, paper bingo cards distract players'attention from playing slot machines and/or table games while a bingo game is going on. In addition, the Kolinsky and Tawil references require players to monitor continuously the TV monitors to determine if they have won. Moreover the references do not inform the winners how they are to be paid the prizes, how to make sure that the bingo cards claimed to be the winning bingo cards are valid and belong to the rightful owners, and how to proceed to the next game. In addition, paper bingo cards also create multiple security and accounting problems. Although substantial progress has been achieved in this direction as described in reviews “The Electronic Management of Information”, Bingo Manager, September 1997 and “Management Information Systems Insure Hall Integrity”, Bingo Manager, June 2000, multiple security, integrity and accounting gaps still persist in the realm of paper bingo cards.

A partial solution to the problem of handling balky, messy and insufficiently secure paper bingo cards is offered by electronic bingo player units that electronically verify bingo cards for the player as described in the following articles “The Electronic Invasion”, Bingo Manger August 1995; “Technology in the Palm of Your Hand”, Bingo Manager, November 1997; “Color and Automation Improve Hand-Held Bingo”, Bingo Manager October 1999; “Electronics Evolve with New Ideas”, Bingo Manager, July 2000 and “Bingo on the Rebound”, International Gaming & Wagering Business, March 2000. Instead of the actual paper bingo cards, the player playing bingo on the electronic bingo unit (also known as “handset”, “portable” or “stationary” unit) is provided with a compact sales receipt generated at the point of sale (POS) terminal. The receipt often lists (by the so-called “face” number) the bingo cards the player is entitled to play. The receipt may also implicitly identify the bingo cards the player is entitled to play in each bingo game of the session by providing a so called “pack number” that algorithmically identifies the “face numbers” of the bingo cards without actually listing each and every purchased bingo card. In either case, the receipt is typically not imprinted with actual bingo cards or card faces. Although a compact receipt is convenient for handling, the electronic player units are generally expensive and labor intensive. In addition, stationary electronic bingo player units occupy coveted floor space on the casino floor; whereas portable player units require frequent recharging and have to be collected at the end of bingo sessions and may easily be damaged by players carrying them around the casino. Most importantly, the electronic bingo player units typically participate in a live bingo session played in a dedicated bingo hall of the casino along with conventional paper bingo cards. In such a bingo session, the overall bingo game is not automated, is labor intensive, and the bingo caller continues to call new bingo numbers until a player loudly announces “bingo”. A sales receipt issued in connection with an electronic bingo player unit may be imprinted with player's identification number and/or name as described in reviews “Keeping Track of Players”, Bingo Manager, February, 1996 and “Management Information Systems Insure Hall Integrity”, Bingo Manager, June, 2000. However, the current use of the player identification data is narrowly limited only for player-tracking purposes, and its full potential remains unrealized.

The paper bingo cards are typically printed in large volume with high-speed printing presses on an inexpensive newspaper-print paper. In some casino bingo halls however more expensive, and more elaborate, computer-printed bingo cards are utilized as described for example, in reviews “Papering the Bingo Industry”, Bingo Manager, April 2000 and “High Stakes Games Create Excitement and Profits”, Bingo Manager, August 2000. Because they are imprinted with unique identification numbers and pricing information, such computer-generated paper bingo cards may conceptually be viewed as defacto sales receipts although they are first and foremost paper bingo cards. In particular, they continue to be bulky, messy and still distract attention of players from slot machines and table games.

On the other hand, totally automatic bingo games not requiring paper bingo cards are also known. However, such bingo games are conducted on stationary electronic player units networked together in a gaming network that may spread across several casinos and, therefore, require expensive equipment that occupies large space on the casino floor. Most importantly, every player must be provided with an individual player unit, even though such a player unit is typically less profitable for the casino than a slot machine. In addition, such games are not conducted in the popular session format and are played individually so that a player is not required to remain at the casino thereby eliminating the benefit to the casino. Further, such player units operate by continuously monitoring the players'account balances to accumulate winnings and deduct the costs of the played bingo cards. As a result, it is impossible for the player and/or auditing authorities to check results of individual bingo games played in case a player dispute arises. In addition, players playing on fully automatic bingo player units can only see the current status of their bingo cards and do not know whether they are the leaders of the game.

The issue of occupying expensive casino floor space by bingo player units may be alleviated by employing the technique disclosed in 4,856,787 to ltkis that claims the concurrent playing of casino games (e.g. poker and video slots) and bingo games on the same video machine. Although the concurrent multi-gaming devices are potentially very beneficial for casinos, they require large up-front capital for the casinos to remove the existing video machines and replace them with new machines. Moreover, a broad utilization of essentially identical machines throughout the casino may decrease the diversity of machines in the casino and, therefore, may decrease casino appeal to the players.

For casinos, the only practical alternative to bingo is keno. Even though the marketing appeal of keno is nowhere near to the marketing appeal of bingo, virtually all casinos offer keno to their patrons due to its relatively low operational costs. The contemporary game of keno is highly automated in that the central computer automatically checks all issued keno cards after the drawing of the twenty keno balls is complete. Computerized keno systems employing at least some of the concepts disclosed in U.S. Pat. Nos. 4,033,588 to Watts, 4,689,742 to Troy, 5,326,104 to Pease et al., and 5,417,424 to Snowden et al. are well known and are widely used by casinos. However, games of keno are vastly different from games of bingo. First, the game of bingo has no predetermined end since the number of drawn bingo balls needed to complete the game is not known in advance. The bingo balls must be drawn until at least one winning bingo card is discovered; whereas, there may be no winning keno cards in any given keno game. It is also possible, although unlikely, for all keno cards to be winners in a given keno game. The prizes won in a keno game are typically fixed and do not depend on the number of participants, whereas a bingo game includes a pre-announced prize that must be shared by all winners. Moreover, keno games have nothing to do with bingo patterns which are the focus of every bingo game. Due to the utilization of bingo patterns and the unpredictability of the game's end, the process of verifying bingo cards is drastically different from the process of matching keno cards with the called keno numbers. In addition, a keno player plays just one keno card per game, which may be played in multiple ways, whereas a bingo player typically plays a large number of bingo cards during every bingo game. Also, the same keno card is typically played in multiple successive keno games (i.e. up to 1000 games are allowed to be played in Nevada on the same keno card), whereas in a bingo session, the cards played by a player typically change from game to game. Further, the live keno game is geared to the player monitoring the process of drawing the keno balls, especially since the player has no way of knowing whether the keno card won without going to the keno counter and having the card checked. Moreover, a player has no way of verifying whether the cashier has told the truth and the cashier has no way of verifying whether the player is submitting a keno card that is rightfully owned by the player. In other instances, a player may lose the keno ticket thereby having no means to recover potential winnings. Most importantly, keno tickets are always imprinted with actual “faces” (i.e., keno numbers picked by the player or automatically picked by the computer). Because players have to carefully mark keno cards with all called keno numbers to know whether their cards are winning cards, keno tickets, similar to bingo cards, distract players from playing slots and table games. Moreover, when a keno card is played in a number of consecutive games, a player has the additional problem of marking the same card over and over in each of the games.

All the above described approaches to automating bingo and keno games have one common denominator, namely they all strive to explicitly show bingo cards to a player, whether in paper and/or electronic format, and try to actively involve a player in the process of gaming. Apparently, all current bingo systems and techniques are based on the absolute postulate that, being a social game, bingo requires a clear presentation of bingo cards and also requires an active player interaction with bingo cards. Although being universally accepted, such axioms are not necessarily true, and the current invention aims at putting them to a rigorous test in a casino environment.

### SUMMARY OF THE INVENTION

The present invention has the primary objective to resolve the casinos'dilemma of whether or not to offer bingo to patrons and, if so, in what form. This and other associated objectives of the invention are achieved primarily by the full computerization of the bingo game coupled with the elimination of bulky, messy, cumbersome and insufficiently secure paper bingo cards.

Architecturally, the present invention is a computer network specifically adapted for playing bingo in a casino environment. The present computer network includes a bingo caller terminal and a number of point of sale (POS) terminals. The bingo caller terminal functions as a file server for the network, a central verifier and an overall game controller. Some of the POS terminals are self-service, player-operated terminals (e.g., wall-mounted kiosks) and some are cashier-operated terminals. The POS terminals, including self-service POS terminals and cashier-operated POS terminals, serve as the vehicle for selling bingo cards to players for the upcoming bingo sessions. Instead of supplying players with bulky stacks of paper bingo cards, the POS terminals issue compact printed sales receipts that determine implicitly the bingo cards participating in the upcoming bingo games. Specifically, the sales receipts determine the cards the player is entitled to play either by the “face numbers” or, preferably, by providing a “pack number” that determines specific cards in accordance with a predetermined algorithm. Unlike paper bingo cards, sales receipts typically do not carry specific card faces and in case of a player dispute, the specific card faces that the player is entitled to play have to be located in a master book that lists all bingo cards available for play in a casino. Frequently, the master book is called “perm” or “permutation” of bingo cards. The sales receipts carry barcoded identification numbers including player-tracking numbers, the latter being read by the POS-embedded card readers from the player-tracking cards.

The bingo caller terminal automatically generates all bingo numbers for the bingo game, or prompts a bingo caller to extract the next bingo ball from a ball hopper, automatically verifies all bingo cards participating in the game in realtime and signals the current status of the game, including the leading bingo sales receipts and bingo cards. Specifically, the caller terminal sequentially generates random bingo numbers and verifies all bingo cards being played each time a new random bingo number is generated. This is achieved by performing a global comparison of the called bingo numbers with all bingo cards playing in the game and with all bingo patterns being played. The caller terminal displays on the TV monitors installed throughout casino the current status of the game including the cards that are closest to winning, the sales receipts the leading cards belong to and the bingo numbers that the leading cards need to win the game. Even though the players do not have paper bingo cards in their hands, the realtime displaying of leading sales receipts allows players to quickly evaluate their chances of winning by simply glancing at the TV monitor to check whether their receipts are listed as the leading receipts. The contemporaneous displaying of leading sales receipts creates an exciting atmosphere similar to horse racing environment.

As soon as the caller terminal detects at least one winning bingo card, it halts further generation of called bingo numbers and signals the end of the current bingo game by sequentially displaying all winning bingo cards, along with the corresponding sales receipt, on TV monitors installed throughout casino. The caller terminal also automatically computes the prizes won by the winning cards and stores in a database the data detailing the outcome of the game, including the prizes won during the game, the winning bingo cards and the corresponding sales receipts. As soon as the current game ends, the caller terminal automatically initiates the next bingo game in the session and so on until the entire session is completed. Upon completion of the current bingo session, the bingo caller terminal automatically begins the next session.

The only required degree of participation by the player during the bingo game is obtaining a sales receipt at a POS terminal. Once a sales receipt is purchased, the player does not have to do anything to win the prize since the bingo caller terminal automatically plays all purchased bingo cards for the player. In a sense, the caller terminal serves as a proxy player of the bingo cards determined by the sales receipt. The player may even leave the casino and come back later, even several days later, to check whether his/her bingo cards won any prizes during any games. The player can do it with the help of a user-friendly self-service POS by simply scanning the barcoded sales receipt at the POS-embedded laser barcode reader. In response to scanning the receipt, the self-service terminal retrieves from the database the prizes, if any, attributable to the player's sales receipt and displays the retrieved prizes on the display. Optionally, the self-service terminal may even dispense the prizes similarly to an automated teller machine (ATM), however, the main intent is to pay the prizes at the cashier-operated POS terminals upon surrendering of the winning sales receipt. The player may also check the status of the sales receipt several times while the session progresses, and may be paid the prizes won during the games completed at the time of checking.

In order to make the paying of the prizes more secure, the player is also required to swipe a player-tracking card at the POS terminal. The player may also observe the progress of the game on the TV monitors installed throughout the casino. However, the player is not required to do so and may play slots, table games or even relax in a restaurant while the bingo cards are continuously and automatically monitored by the bingo caller terminal.

Optionally, some players, typically “high rollers”, may be provided with portable radio-controlled player units known in the art that continuously display the status of the bingo cards attributable to the sales receipt. With a fully automatic portable player unit, the player can play a slot machine and simply glance from time-to-time at the display of the portable player unit to determine the current status of the bingo cards. Such an arrangement effectively anchors the bingo player to the slot machine for the duration of the bingo session and yet does not require any valuable space on the casino floor for a dedicated bingo terminal. Therefore, the casino achieves the marketing goal of attracting bingo players while encouraging and facilitating playing of highly profitable slot machines.

### BRIEF DESCRIPTION OF THE DRAWINGS

FIG. 1 is a diagrammatic representation of an automated system for playing bingo in a casino environment embodying the principles of the invention;

FIG. 2 is a representation of a sales receipt;

FIG. 3 is a representation of another embodiment of a sales receipt;

FIG. 4 is a representation of a TV monitor screen showing the current status of a bingo game in progress;

FIG. 5 is a representation of a TV monitor screen showing the outcome of a completed bingo game;

FIG. 6 is a representation of a display screen of a self-service point of sale terminal showing prizes attributable to a sales receipt;

FIG. 7 is a representation of a display screen of a self-service point of sale terminal showing that a sales receipt is not entitled to any prizes;

FIG. 8 is a representation of a display screen of a cashier point of sale terminal showing outstanding balance of winnings due to a sales receipt;

FIG. 9 is a representation of database incoming and outgoing data flow;

FIG. 10 is a flow chart of the Main Task performed by a cashier terminal;

FIG. 11 is a flow chart of the Main Task performed by a caller terminal;

FIG. 12 is a flow chart of the Generate Called Bingo Number Routine (random number generator version);

FIG. 13 is a flow chart of Generate Called Bingo Number Routine (ball hopper version);

FIG. 14 is a flow chart of the Verify Card Routine;

FIG. 15 is a flow chart of the Compute Payouts Routine;

FIG. 16 is a flow chart of the Schedule Next Game Routine; and

FIG. 17 is a flow chart of the Self Service POS Main Task;

### DESCRIPTION OF THE PREFERRED EMBODIMENT

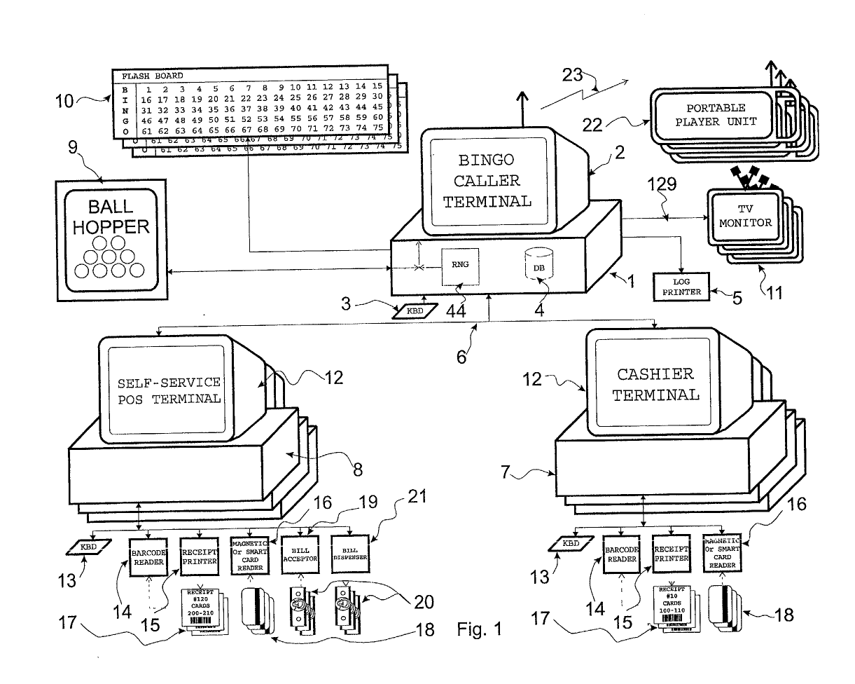

FIG. 1 illustrates one form of the automatic system for playing bingo suitable for a casino environment. The system of FIG. 1 is a network of computing nodes centered around the bingo caller terminal 1. The bingo caller terminal 1 is a general-purpose computer, such as a personal computer (PC) equipped with a touch-screen monitor 2, keyboard 3, hard drive 4, and log printer 5. The bingo caller terminal 1 is interfaced via a wired communication network 6, such as Ethernet, with a plurality of cashier terminals 7 and self-service, player-operated terminals 8. In addition, the bingo caller terminal 1 is interfaced with a bingo ball hopper 9 and a plurality of bingo flash boards 10 installed throughout the casino.

In bingo industry parlance, the bingo ball hoppers are also known as ball poppers, consoles, ball racks, etc. The function of the ball hopper 9 is to generate randomly called bingo numbers in the range of 1 to 75 in the American version of the game and in the range of 1 to 90 in the British version of the game. The ball hopper is operated by a bingo caller who manually extracts a ping-pong-type plastic ball from the ball hopper and announces the number imprinted on the extracted ball. More modern, closed-loop, or hands-free, ball hoppers feed bingo balls automatically without a bingo caller handling them.

The function of the flash board 10 is to display the called bingo numbers to the players. The ball hopper 9 is interfaced digitally with bingo caller terminal 1 that in its turn is interfaced with a plurality of bingo flash boards 10 as known in art. For example, interfacing of a ball hopper with a bingo caller terminal and flash board is provided in U.S. Pat. No. 4,332,389 to Lloyd. Via a closed circuit TV cable 129, the bingo caller terminal 1 is further interfaced with a plurality of TV monitors 11 installed throughout the casino. The TV monitors 11 display the image of the latest bingo ball to the players.

Each of the cashier terminals 7 is also a general-purpose computer equipped with a variety of peripherals including a touch-screen monitor 12, a keyboard 13, a barcode reader 14, a receipt printer 15 and a magnetic card or smart card reader 17. The receipt printer 15 prints the sales receipts 17, the barcode reader 14 reads sales receipts 17 and the magnetic card reader 16 reads player-tracking cards 18.

In addition to cashier-operated terminals 7, the bingo caller terminal 1 is also networked with self-service, player-operated point of sale terminals 8. The self-service terminal 8 is equipped with the same peripherals as the cashier terminals 7 plus a bill acceptor 19, also known in the gaming industry as a bill validator, that is capable of reading legal bills of various denominations 10 and the bill dispenser 21.

The bingo caller terminal 1 also controls a plurality of portable bingo player units 22 over a wireless radio-channel 23. For example, a wireless communication between a bingo caller terminal and a radio-controlled player unit is provided in U.S. Pat. No. 4,624,462 to Itkis.

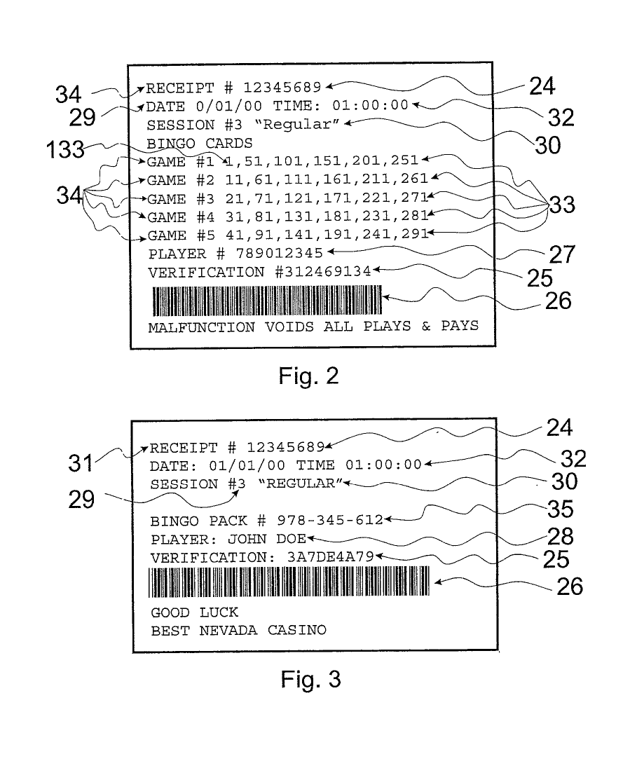

Both the cashier-operated point of sale terminal 7 and self-service, player-operated point of sale terminal 8 issue similar sales receipts 17, such as illustrated in FIGS. 2 and 3. The sales receipts 17 are printed by the receipt printers 15. The sales receipts 17 of FIGS. 2 and 3 are uniquely identifiable by their sequence numbers 24 and their verification numbers 25. The sales receipts 17 of FIGS. 2 and 3 also carry a unique barcode 26. In its simplest form the barcode 26 is a binary representation of the sequence number 24. In more elaborate implementations, barcode 26 may be encoding the sequence number 24 in accordance with a predetermined algorithm or be at least partially independent on the sequence number 24 and may even be randomly generated by the point-of-sale terminals 7 and 8. Both the sales receipt of FIG. 2 and the sales receipt of FIG. 3 identify the player to whom the receipt is issued. Specifically, the receipt of FIG. 2 identifies the player by the player identification number 27 and the receipt of FIG. 3 identifies the player by the name 28. The receipts of FIGS. 2 and 3 identify the bingo session to be played by player, are dated with a date mark 31 and are stamped with the time tag 32. The receipts of FIGS. 2 and 3 also identify the cards to be played in the session for which they correspond.

The receipt of FIG. 2 identifies the specific cards 33 to be played in the session 29 on a game-by-game basis 34. The set of cards 33 starts with a base card 133, in this case card number one. Note that each bingo card in the total set of bingo cards being played in the session 29, collectively called “permutation”, is identified by its own sequential identification number known as a “face number”. The receipt of FIG. 3 is more cryptic in that it provides only a so-called pack number 35 that is an encoded representation of bingo cards to be played in the bingo session in accordance with a predetermined algorithm that maps the pack number 35 into specific bingo cards in each game of the session. For example, the pack number may simply be a concatenation of the first card to be played in the first game of the session with the number of cards to be played in the game.

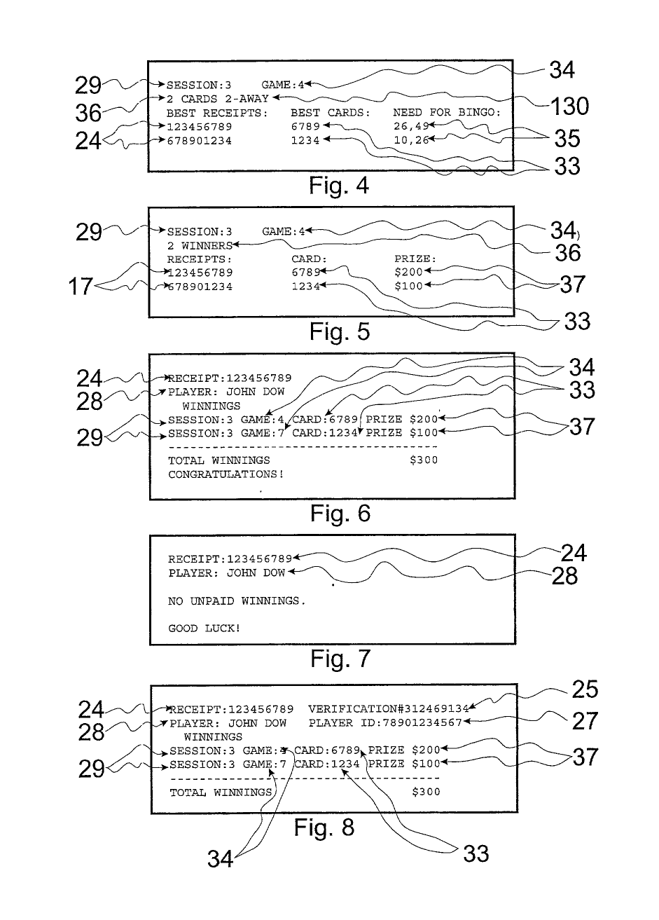

FIG. 4 illustrates a game status screen displayed on the public announcement TV monitors 11. Specifically, the screen of FIG. 4 identifies the session 29 and the game 34 being played along with the overall status of the game by indicating the number of bingo cards that are the best bingo cards 23 (i.e., the closest to winning bingo cards), how many bingo numbers on the best cards remain to be covered 130 (i.e., how many numbers “away from bingo” the best bingo cards 33 are), what bingo numbers 35 have to be called for the best bingo cards to become winners, and what sales receipt numbers 34 the best bingo cards correspond.

FIG. 5 illustrates the status of a completed bingo game displayed on the TV monitors 11. In particular, FIG. 5 indicates the current session 29, the just completed bingo game 34 and the total number of winners 36. In addition, FIG. 5 shows the winning cards 33, the sales receipt numbers 34 that the winning cards correspond, and the prizes 37 won by the winning bingo cards 33.

FIG. 6 illustrates the screen displayed on the self-service player-operated POS terminal 8 appearing in response to a scanning of barcode 26 on the sales receipt 17 by the barcode reader 14. Specifically, the screen displays the sales receipt sequence number 24, the player name 28, and the prizes 37 won by the player along with an indication of particular sessions 29 and games 34 during which prizes were won. A companion FIG. 7 shows the screen appearing on the self-service terminal 8 in the event there are no unpaid prizes attributable to the sales receipt 17. FIG. 8 shows a display screen nearly identical to the display screen of FIG. 6, except that the former also displays a player-tracking identification number 25. The display of FIG. 8 appears on the screen of the cashier point of sale terminal 7 upon an occurrence of the following two events: (a) scanning of the barcode 26 on the sales receipt 17 by barcode reader 14, and (b) reading of the player-tracking card 18 by magnetic card reader 16.

All computer terminals shown in FIG. 1 including bingo caller terminal 1, self-service terminals 8 and cashier terminals 7 execute appropriate application software packages in a multitasking environment such as a Linux® environment. Each of the computers stores and archives necessary data on preferably mirrored hard disks to assure data preservation in case of power disappearance. However, other storage media can serve the same function. The bingo caller terminal 1 acts as a file server for the entire system of FIG. 1 and archives all necessary data in a database, such as SQL database (e.g. Oracle® database stored on a hard disk). The details of general design and operation of computer hardware and software including databases and multitasking operating systems are presumed to be well known to the practitioners of the art and are not detailed here.

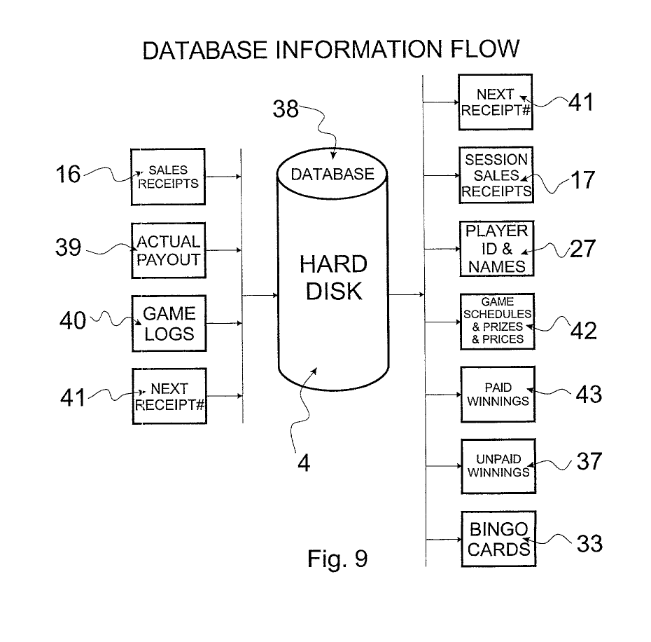

Instead, particular attention is paid to critical aspects of operation of the system of FIG. 1 presented in flowcharts of FIGS. 9 through FIG. 17. The flow of incoming and outgoing data from the database 38 residing on hard drive 4 is presented in FIG. 9. The database 38 receives and archives the following data: sales receipts 17, actual payouts 37, game logs 40 and next receipt sequence number 25. The following data can be retrieved from the database 38: next receipt sequence number 24, session sales receipts 17, player identification numbers 27 and names 28, game schedules, including prizes and prices 42, paid winnings 43 and unpaid winnings 37.

The system of FIG. 1 operates in the following manner. A player approaches a cashier point of sales terminal 7, passes a player tracking card 18 through the magnetic card reader 16 and advises the cashier of the number of bingo packs to be played during the next session. Thereafter, the cashier enters the requested number of bingo packs into the POS terminal 7 via the touch screen 12 and informs the player of the amount due. The player then pays the necessary amount and receives a barcoded sales receipt illustrated in FIG. 2 or 3. The player may optionally receive a portable player unit 22 at the POS terminal 7. The player then proceeds to play slots or table card games or may even leave the casino. Typically, a large number of players will purchase the right to participate in the upcoming bingo session in the above-described manner and all their sales receipts 17 will be stored in the database 38 residing on hard drive 4.

While players play other casino games, the bingo caller announces the start of the next bingo session at a prescheduled time. The bingo caller terminal 1 displays the session start message on the TV monitors 11 and announces the session start by playing prerecorded, or synthesized, voice messages through the TV monitors 11. The bingo caller terminals 1 also retrieve from the database 38 all bingo cards participating in the first game of the session as specified in the archived sales receipts 17. Subsequently, the bingo caller terminal 1 begins generating random bingo numbers utilizing built-in random number generating means 44. As each new random bingo number is generated by RNG 44, the bingo caller terminal 1 automatically verifies all bingo cards participating in the game by comparing the card contents with called bingo numbers and bingo patterns being played. The progress of the game, in particular the best bingo cards, is automatically displayed on TV monitors 11 as shown in FIG. 4, under the control of bingo caller terminal 1. This allows the players to monitor the status of the game from time to time while also playing slots or the like. The process continues until bingo caller terminal 1 detects that at least one participating player has achieved bingo. The bingo caller terminal 1 then computes payouts due the winners, archives the outcome of the game, including the winning cards and the prizes won, in the database 38 and displays the outcome on the TV monitors 11 as shown in FIG. 5. After a brief pause, bingo caller terminal 1 retrieves from the database 38 bingo cards participating in the next game and automatically starts calling bingo numbers for the next game until a winner is found in the manner described above. Eventually, all games of the current session are played as presented above and bingo caller terminal 1 automatically starts the next prescheduled bingo session.

At any time during and after the bingo session, a player may approach a self-service terminal 8 and pass the sales receipt 17 under a barcode reader 14. In response, the self-service terminal 8 retrieves from the database 38, over the network 6, the unpaid winnings data by the sales receipt sequence number 24 and displays either the screen of FIG. 6, wherein the player is due some prize, or the screen of FIG. 7, wherein the player is not due any prizes or was already paid all prizes previously. Assuming self-service terminal 8 indicates the player is due a prize, the player can then proceed to the cashier POS terminal 7 to claim the prize. At the cashier POS terminal 7, the player scans the sales receipt 17 again and also must pass the player tracking card 18 through a magnetic card reader 16. The cashier POS terminal 8 retrieves from the database 38, over the network 6, the original sales receipt 17 and verifies that the player-tracking card 18 presented by the player matches the sales receipt 17. Note, that the reading of the player-tracking card 18 is not required at the self service terminal 8, but it is desirable at the cashier POS terminal 7 to validate the identity of the alleged winner. Similarly, the self-service POS terminal 8 does not display either the player-tracking identification number 27 or the verification number 25. Once paid, the player can continue to play slots or the like and check later to determine whether the player has additional prizes.

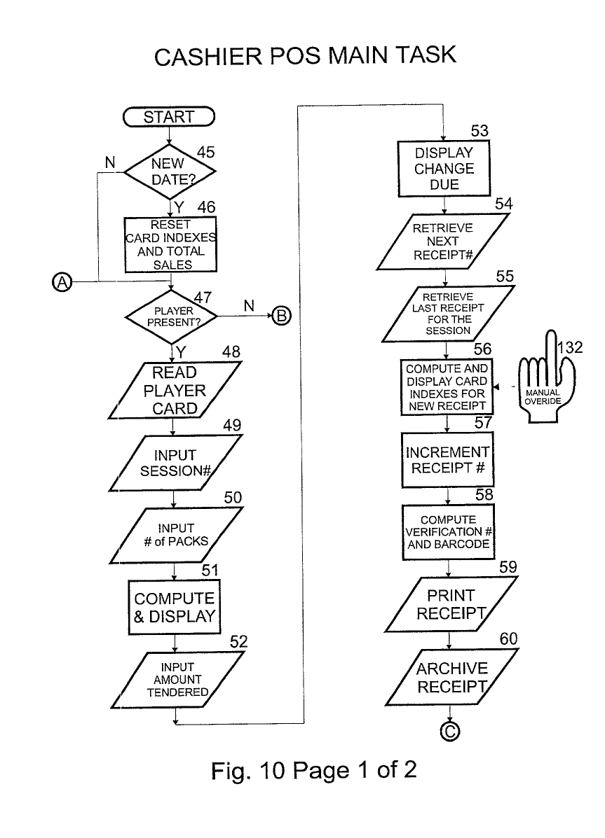

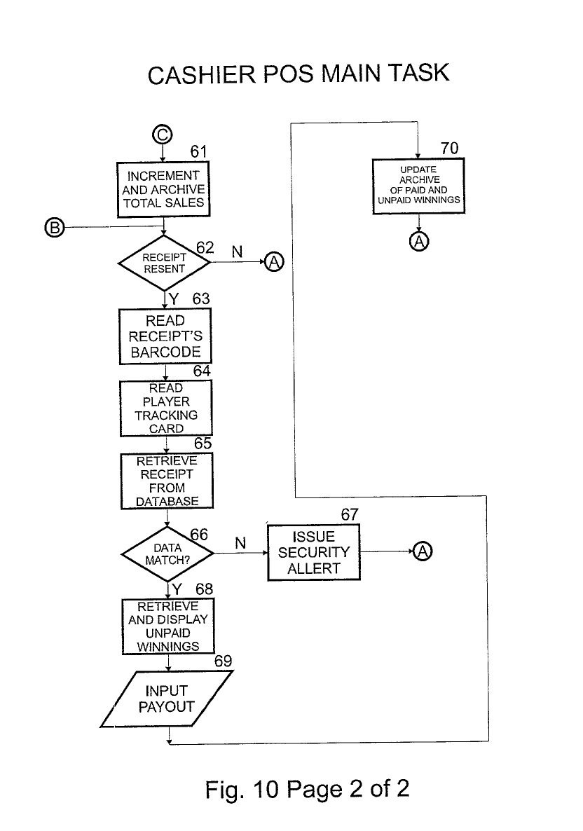

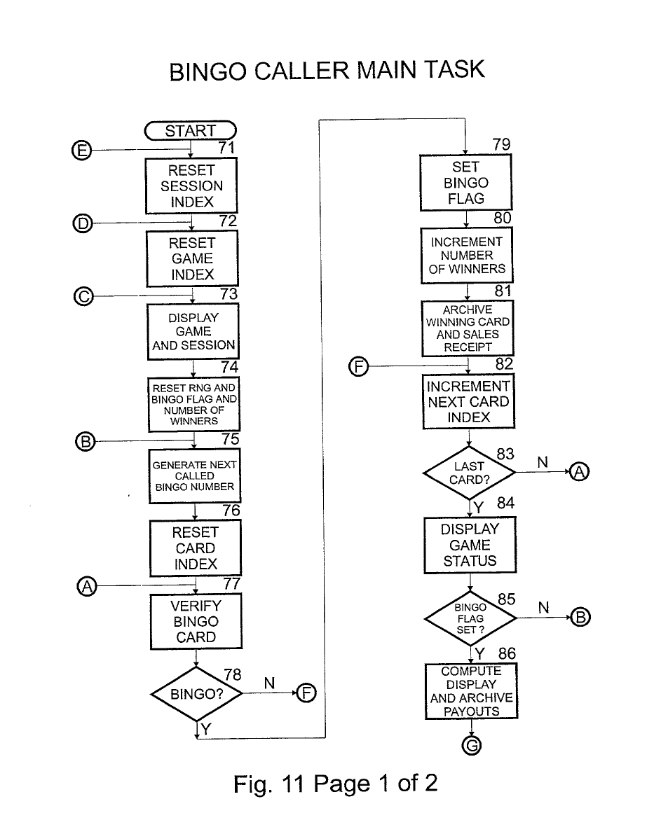

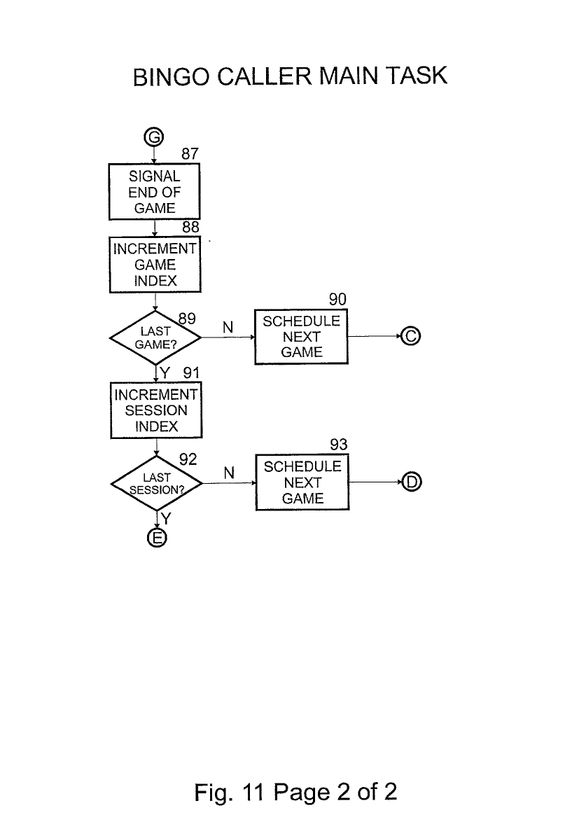

The above-described sequence of events of the system illustrated in FIG. 1 represents only one specific example of the mode of operation. The flowcharts of FIGS. 11 through 16 provide additional insight into the capabilities of the system. Specifically, the flow chart of FIG. 10 illustrates a particular implementation of cashier POS terminal 7 main task. Upon entering the task, the POS terminal 7 checks whether the date has been changed in the step “NEW DATE?” 45. If so, the card indexes are reset in step “RESET CARD INDEXES AND TOTAL SALES” 46 in order to start the selling of the bingo cards from the card number one for the new day. Otherwise, the sales of the bingo cards are continued from the last point archived in the database 38. More precisely, the sales for each bingo session are tracked separately to allow sales of the bingo cards for numerous sessions at once, eliminating the need for the player to return to POS terminal 7 for each session. The main loop of the cashier POS main task starts with step “PLAYER CARD PRESENT?” 47 to check whether a player transaction is about to start. If no player-tracking card 18 is detected by the POS terminal 7, the processing proceeds to step “RECEIPT PRESENT?” 62. If however, the player-tracking card 18 is detected, it is read in step “READ PLAYER CARD” 48 . Subsequently, a cashier enters the bingo session numbers the player desires to play in step “INPUT SESSION NUMBER” 49 and the number of bingo packs, or bingo cards, the player desires to purchase in step “INPUT # OF PACKS” 50. The session number and the number of packs entered by the cashier are utilized by cashier POS terminal 7 to compute and display the amount due from the player in accordance with the schedule of games, including prizes and prizes stored on the database 38. The cashier then enters into the terminal 7 the amount tendered by the player in step “INPUT AMOUNT TENDERED” 52 and the terminal 7 displays the amount of change due, if any, in step “DISPLAY CHANGE DUE” 53. Subsequently, the terminal 7 retrieves from the database 38 the sequence number of the next sales receipt 17 to be issued in step “RETRIEVE NEXT RECEIPT #” 54 followed by retrieval from the database 38 of the last sales receipt 17 for the entered session in step “RETRIEVE LAST RECEIPT FOR THE SESSION” 55.

Beginning with the card indexes of the last sales receipt 17, the terminal 7 computes new card indexes for the bingo cards to be sold to the player by incrementing the retrieved card indexes by predetermined amounts (i.e. by fifty) in step “COMPUTE AND DISPLAY CARD INDEXES FOR NEW RECEIPT” 56. For example, in case of the sales receipt 17 shown in FIG. 2, the next sales receipt to be sold will entitle the player to play bingo cards starting from the base card number 133, (e. g. card number three hundred one in the first game, and from card three hundred eleven in the second game, etc. ) The specific amounts the card indexes are incremented from pack to pack and from game to game vary significantly from vendor to vendor of card “permutation” and are well known in the bingo industry as described in the review article “Paper Security”, Bingo Manager, October, 1995 and “Papering the Bingo Industry”, Bingo Manger, April, 2000. Subsequently, the POS terminal 7 increments the receipt sequence number, previously retrieved in step 54, and utilizes it as the new receipt sequence number for the sales receipt 17 in progress in step “INCREMENT RECEIPT #” 57. The next step performed is the computation of the verification number 25 and the barcode 26 for the new sales receipt 17 in step “COMPUTE VERIFICATION # AND BARCODE” 58. A broad variety of techniques for computation of verification number 25 is available. Generally, the verification number encodes the contents of the sales receipt 17 according to some predetermined algorithm. For example, the verification number of the sales receipt 17 in FIG. 2 is a simple sum of the receipt sequence number 24 and the player-tracking identification number 27. A more secure approach is utilization of a cyclic redundancy code (“CRC”) for the entire sales receipt 17 as a verification number 25. However, virtually any unique verification number, including a randomly generated number, can be imprinted on the sales receipt 17.

Multiple implementations of barcodes, including UPC barcodes, are well known in the industry. Typically, the barcode 26 simply represents the sequence number 24 of the sales receipt 17. However, the barcode 26 may be more elaborate and may, for example, include several verification digits along with the sequence number 24. Once computation of verification code 25 and barcode 26 is complete, the POS terminal 7 prints out sales receipt 17, such as shown in FIG. 2, in step “PRINT RECEIPT” 59 and archive the sales receipt 17 in the database 38 in step “ARCHIVE RECEIPT” 60. Subsequently, the program increments and archives total sales in step “INCREMENT AND ARCHIVE TOTAL SALES” 61. At this point, the process of issuing a new sales receipt 17 is complete and the POS terminal 7 proceeds to next subtask in step “RECEIPT PRESENT?” 62.

The purpose of step 62 is to determine whether a player must be paid out any prizes owed. If a sales receipt 17 is detected by the barcode reader 14, the barcode 26 is scanned-in in step “READ BARCODE” 63. Thereafter, the player tracking card 18 is read in the step “READ PLAYER TRACKING CARD” 64. Subsequently, the data corresponding to the read sales receipt 17 is retrieved from the database 38 in step “RETRIEVE RECEIPT FROM DATABASE” 65. Immediately, the retrieved data is compared with the read player-tracking card 18 identification number 27 in step“DATA MATCH?” 66. If the retrieved sales receipt 17 belongs to a different player as signified by a mismatched player-tracking data, a security alert is issued in step “ISSUE SECURITY ALERT” 67, and the main loop is re-entered . If the match is successful, the unpaid winnings 37, if any, belonging to the sales receipt sequence number 24 are retrieved from the database 38 and displayed to the cashier in step “RETRIEVE AND DISPLAY UNPAID WINNINGS” 68. At this point, the cashier pays out the amount due to the player and enters it into the POS terminal 7 as specified in the step “INPUT PAYOUT” 69. Once the act of payment is confirmed in step 69, the POS terminal 7 updates the archives of both payments and unpaid prizes on the database 38. Note that step “READ PLAYER TRACKING CARD” 64 can be substituted with the functionally equivalent step of manually entering a player tracking number 27 imprinted on the player-tracking card 18. Moreover, rather than manually entering a player-tracking-number 27 a verification number 25 can be entered manually, or electronically, and then matched with the contents of the retrieved sales receipt 17 in step “DATA MATCH?” 66.

The flowchart of FIG. 11 illustrates a particular implementation of the main task of the bingo caller terminal 1. The main task is responsible for running the entire game of bingo on behalf of all participating players, including the automatic detection of bingo on any of the participating bingo cards and automatic advancement of the current game to the next game as soon as a bingo is detected. Specifically, starting from the entry point, the main task proceeds to the re-setting of the current session index in the step “RESET SESSION INDEX” 71. Typically, a casino offers several sessions of bingo every day whereby each session consists of ten bingo games approximately six minutes long. Subsequently, the main task resets the game index in the step “RESET GAME INDEX” 72 and displays on the TV monitors 11 and the caller's touch-screen monitor 2 the current session and game numbers. Thereafter, the random number generator (“RNG” 44) is reset and enabled in step “RESET RNG” 74. For the simplicity of initial presentation, it is presumed that the external ball hopper 9 of FIG. 1 is not present, and instead, an internal free running software-based random number generator 44 is utilized. In addition to RNG 44, the “BINGO FLAG” and “NUMBER OF WINNERS” variables are reset in the same step 74.

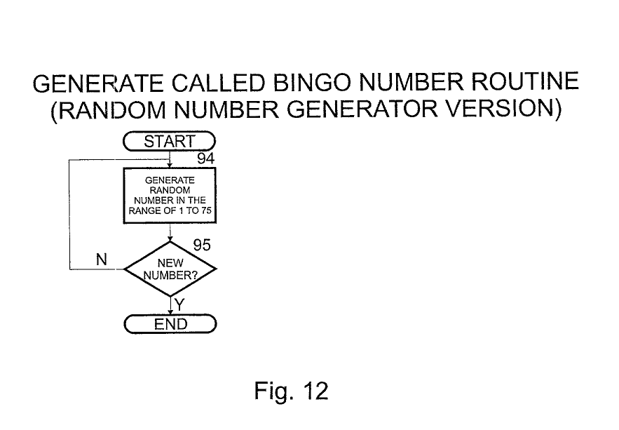

The main task initialization process being complete, the main task proceeds to “GENERATE NEXT CALLED BINGO NUMBER” step 75 wherein the current random called bingo number is generated as illustrated in more detail in the flowchart of FIG. 12. Subsequently, the card index variable is rest in step “RESET CARD INDEX” 76 and the main task is ready to verify the first bingo card being played. It should be noted that throughout this document the verb “verify” is ascribed a special meaning gained in the art of bingo. Specifically, the words “verify”, “verification” and “verifier” refer respectively to the action of, the process of and the device for comparing the informational contents of a bingo card with the called bingo numbers and the patterns being played in the bingo game. For example, see U.S. Pat. Nos. 4,373,726 to Churchill et al., 4,378,940 to Gluz and 4,455,025 to Itkis.

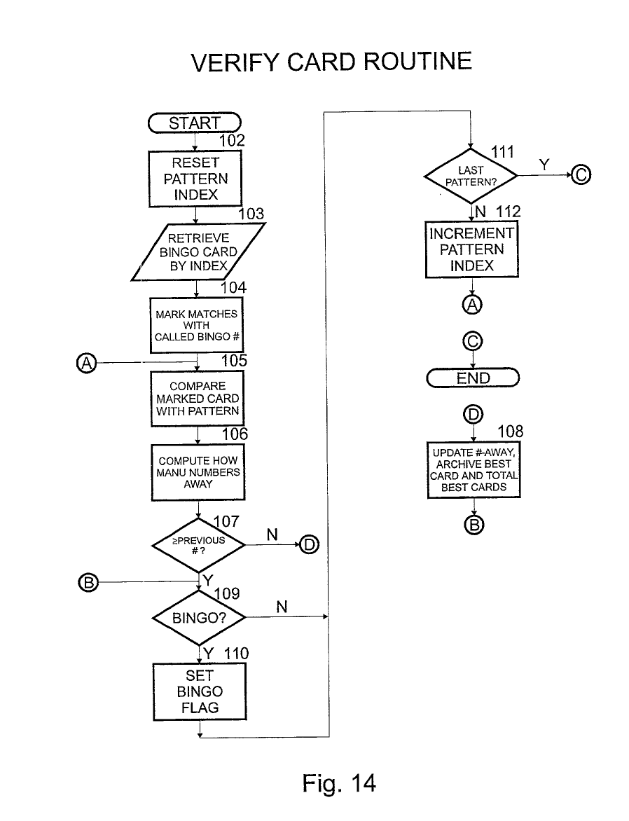

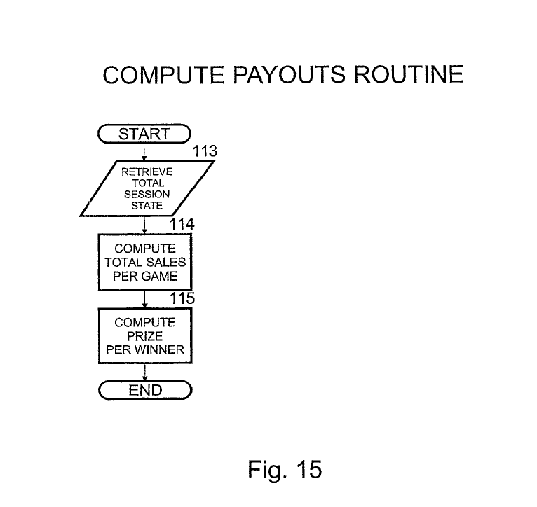

The actual verification of the first and of all subsequent bingo cards is performed in the step “VERIFY BINGO CARD” 77 as more fully illustrated in FIG. 14. Once the verification of the current bingo card pointed by the current “CARD INDEX” variable is complete in step 77, a check is made to determine whether the just verified bingo card achieved “BINGO” status in step “BINGO?” 78. If so, the “BINGO FLAG” variable is set in step “SET BINGO FLAG” 79, the “NUMBER OF WINNERS” variable is incremented in step “INCREMENT NUMBER OF WINNERS” 80, and the identification number of the winning bingo card is archived in the database 38 residing on the bingo caller computer together with the sequence number of the sales receipt 24 the winning card corresponds. The above-described archiving is performed in the step “ARCHIVE WINNING CARD AND SALES RECEIPT” 81. Once verification of the winning bingo card and its archiving is complete, the “CARD INDEX” variable is incremented in step “INCREMENT CARD INDEX” 82. The incrementing of the card index is performed regardless of whether the current bingo card is a winning card or not. The operation of incrementing the “CARD INDEX” variable leads to the check of whether all cards were verified in step “LAST CARD?” 83. If not, the processing returns to step “VERIFY BINGO CARD” 77. If so, the current game status is displayed on the TV monitor 11 in step “DISPLAY GAME STATUS” 84 as shown in FIGS. 4 or 5. Subsequently, a check is made to determine whether “BINGO FLAG” was set in step 79. If not, the processing returns to generating the next bingo number in step 75. Importantly, the return to generation of the next called bingo number may be artificially delayed for some time. This may be desirable in case of high-performance bingo caller terminal 1 that may complete verification of bingo cards in a fraction of a second, especially if very few cards are played. The artificial delay may be necessary to give a chance for the players observing TV monitors 11 to catch up with the game progress. If, however, a “BINGO FLAG” was set, the computation, displaying and archiving of game payouts is performed in step “COMPUTE, DISPLAY, AND ARCHIVE PAYOUTS” 86 as more fully illustrated in FIG. 15. This completes processing of the current bingo game, and bingo caller terminal I causes TV monitors 11 and touch-screen monitor 2 to display the end of game message in step “SIGNAL END OF GAME” 87. If the RNG 44 is utilized as a source of random called bingo numbers, the bingo caller terminal 1 halts further operation of RNG 44 and proceeds to the next step 88. However, if a ball hopper 9 is utilized as a source of random called bingo numbers, the bingo caller terminal issues an advisory message to an operator to drop the balls lodged in the console back into the ball hopper 9.

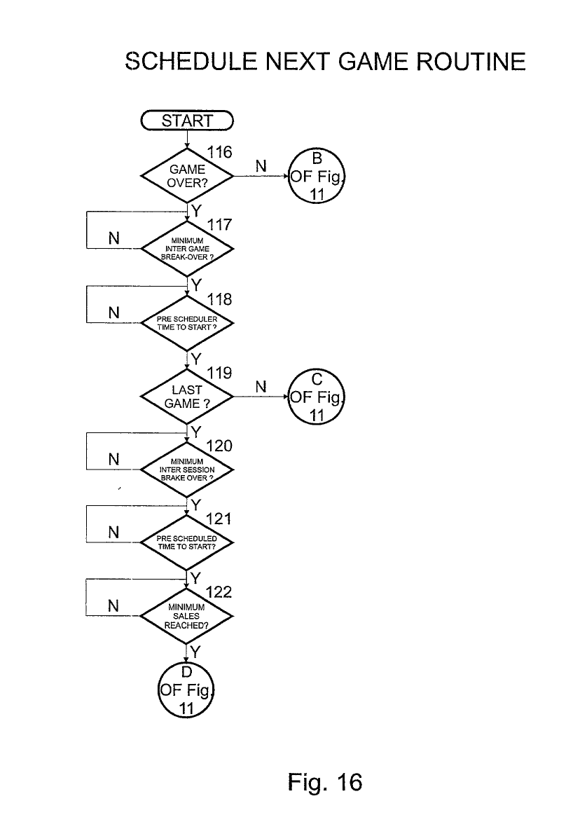

Regardless of the type of the random number generating process (i.e., automatic or manual) the main task initiates the next bingo game in the session by performing the step “INCREMENT GAME INDEX” 88. If incrementing of “GAME INDEX” variable results in advancement beyond the last game in the current bingo session as may be detected in the step “LAST GAME?” 89, the current session index is incremented in step “INCREMENT SESSION INDEX” 91. If however the “GAME INDEX” variable incremented in step 88 is not beyond the end of current bingo session as determined in the step “LAST GAME” 89, the processing returns to step “DISPLAY GAME AND SESSION” 73. Importantly, the beginning of the next bingo game and/or session may be artificially delayed for some time, especially in case of a high-performance bingo caller terminal 1. For example, the start of the next session may be delayed until the beginning of the next hour or until a certain level of sales for the next bingo session is achieved as more fully illustrated in the flowchart of “SCHEDULE NEXT SESSION GAME” routine in FIG. 16. The artificial delay may be necessary to give a chance for the players observing TV monitors 11 some respite between games and sessions, and more importantly for the casino, to allow players to get new sales receipts 17 for the next session. Once the session index is incremented in step “INCREMENT SESSION INDEX” 91, the incremented session index is checked in step “LAST SESSION?” 92. If the incremented session index points to a prescheduled next session, the processing returns to the step “RESET GAME INDEX” 72 after time-scheduling of the next session is complete in step “SCHEDULE NEXT GAME” 90. If not, the processing returns to step “RESET SESSION INDEX” 71 after time-scheduling of the next session is complete in step “SCHEDULE NEXT GAME” 90.

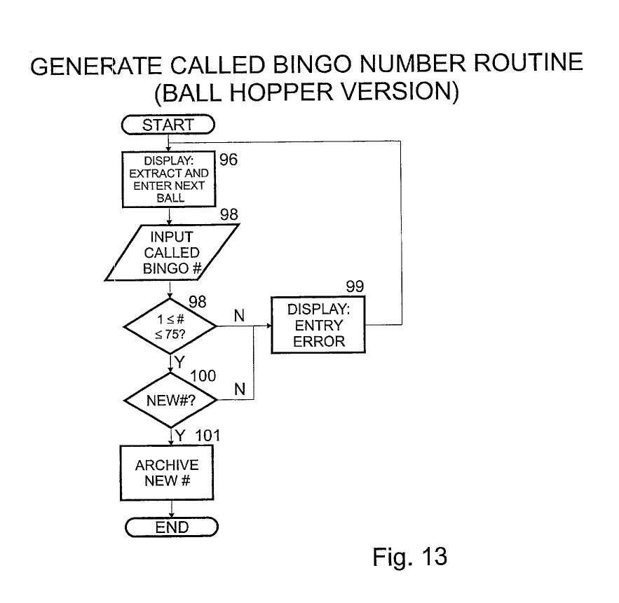

The specific subroutines called by main task of bingo caller terminal 1 are illustrated in FIGS. 12 through 17. In particular, FIGS. 12 and 13 provide details of generating called bingo numbers. FIG. 12 illustrates the automatic generation of random bingo numbers by the RNG 44 built into bingo caller terminal 1, whereas, FIG. 13 illustrates manual generation of called bingo numbers by ball hopper 9. Specifically, RNG-based generation of called bingo numbers is straight-forward. Bingo caller terminal 1 simply generates a random number in the range of one to seventy five (an American version of bingo is assumed.) using a standard software routine for generating pseudo-random numbers. This is performed in step “GENERATE 1 <=#<=75” 94. The generated random number is checked to determine if it is a new called number in step “NEW NUMBER” 95 and, if so, the routine exits. Otherwise, the routine loops back to step 94. Note that the entire process of generating called bingo numbers illustrated in FIG. 12 is totally automatic and is performed without any human involvement.

However, the process illustrated in FIG. 13 does require human involvement. Specifically, it starts with issuing an advisory “EXTRACT AND ENTER NEXT BALL” to a bingo caller. This is done in step “DISPLAY: EXTRACT AND ENTER NEXT BALL” 96. The operator or bingo caller then manually extracts the next bingo ball from ball hopper 9 and enters the number of the ball into bingo caller terminal 1 via touch-screen 2. The terminal 1 then inputs the entered ball number in step “INPUT CALLED BINGO #” 97 and subsequently checks the value of the number in step “1 <=#<=75?” 98. If the number is out of range, an advisory message is displayed on screen 12 “ENTRY ERROR”. This is performed in step “DISPLAY: ENTRY ERROR” 99 and subsequently the routine loops back to the very beginning. If however the entered number is in range, it is checked to determine that it is a new called bingo number in step “NEW #?” 100. If not, the error message is displayed in step 99, and the routine loops back to the beginning step 96. If the number is indeed new, it is archived in step “ARCHIVE NEW #” 101 and is used as a bonafide called bingo number by main task.

FIG. 14 provides details of “VERIFY CARD” routine that starts with resetting the pattern index in step “RESET PATTERN INDEX” 102. Typically, several bingo patterns are played concurrently in the same bingo game. For example, “crazy letter L” pattern includes four sub-patterns, each forming a capital letter “L” in a certain position. Next, the bingo card to be verified is retrieved from the database 38 in step “RETRIEVE NEXT BINGO CARD BY INDEX” 103. Subsequently, the retrieved bingo card is compared with all bingo numbers called in step “MARK MATCHES WITH CALLED BINGO NUMBERS” 104, and all discovered matches between the bingo card contents and the called bingo numbers are marked and saved. Now, the marked bingo card is compared with each bingo pattern being played. This is achieved in steps 105 through 112. The loop starts with step “COMPARE MARKED CARD WITH PATTERN” 105. In this step, the marked bingo numbers are compared with the current bingo pattern and the matches between the pattern and the marked bingo numbers are detected and highlighted. In the next step “COMPUTE HOW MANY NUMBERS AWAY” 106, the highlighted matches are counted out to compute how many numbers away from bingo the bingo card is currently. Thereafter in step “>=PREVIOUS #?” 107, the computed number is compared with the previous absolute record of proximity of any bingo card being played with any bingo pattern being played. If it is found that the current bingo card and the current bingo pattern yield a greater or equal proximity to winning then the previous record, the record of the “number-away” in the database 38 is updated in step “UPDATE #-AWAY AND ARCHIVE BEST CARD” 108. In addition, the bingo card being currently processed is added to the list of best cards and the specific numbers the card needs to complete bingo are noted and stored in the database 38. The information on the best card obtained in the above-described manner is used to form the display screen shown in FIG. 4. It is possible that the card being processed already achieved bingo which is checked in step “BINGO?” 109. If so, the information about the bingo card status that was derived in step 106 is utilized to form a display screen of FIG. 5 and the “BINGO FLAG” variable is set in step “SET BINGO FLAG” 110. If the pattern being checked is the last on the list as determined in step “LAST PATTERN?” 111, the routine is exited. Otherwise, the processing is looped back to step 105, after the pattern index is incremented in step “INCREMENT PATTERN INDEX” 112.

FIG. 15 illustrates a flow chart of Compute Payout Routine. For clarity of presentation, a simplifying assumption is made that all bingo packs and cards participating in the current session are sold at the same price. The routine begins with the step “RETRIEVE TOTAL SESSION SALES” 113 in which the final figure for the total session sales accumulated in the step 61 of Cashier POS Main Task is retrieved from the database 38. Thereafter, a prize available for the game is computed in step “COMPUTE TOTAL SALES PER GAME” by dividing the retrieved total sales data by the number of games included in the session. Subsequently, the available prize is divided equally between all the winners in step “COMPUTE PRIZE PER WINNER” 115. Note that the total number of winners is computed in step 108 of Verify Card Routine. A person skilled in the art can easily generalize the Compute Payout Routine for the case of multi-level prizes and also for the case of fixed rather than parimutuel prizes.

FIG. 16 illustrates Schedule Next Game Routine. The routine begins with the test “GAME OVER?” 116. If game is not complete, the routine immediately exits. If the game is completed, the routine makes sure that a predetermined minimum time passed since the game ended by executing a wait loop in step “MINIMUM INTER-GAME BREAK OVER?” 117. If so, the routine will not start the next game unless a certain prescheduled time for the start of next game is reached. This is assured by the wait loop around step “PRESCHEDULED TIME TO START?”. If so, the test “LAST GAME?” is performed in step 119. If the current game is not the last game in the session, processing returns to the Bingo Caller Main Task. If however, the just completed game was the last game in the session, then the three consecutive tests “MINIMUM INTER-SESSION BREAK OVER?”120, “PRESCHEDULED TIME TO START?” 121 and “MINIMUM SALES REACHED?” 122 are performed to make sure that a minimum break between sessions lapsed, a prescheduled time to start the next session is reached, and most importantly, that a predetermined target level for sales is reached. The last test is needed to assure that at least a certain minimum number of bingo cards are sold for the next session and that the level of participation by players in the next session is achieved.

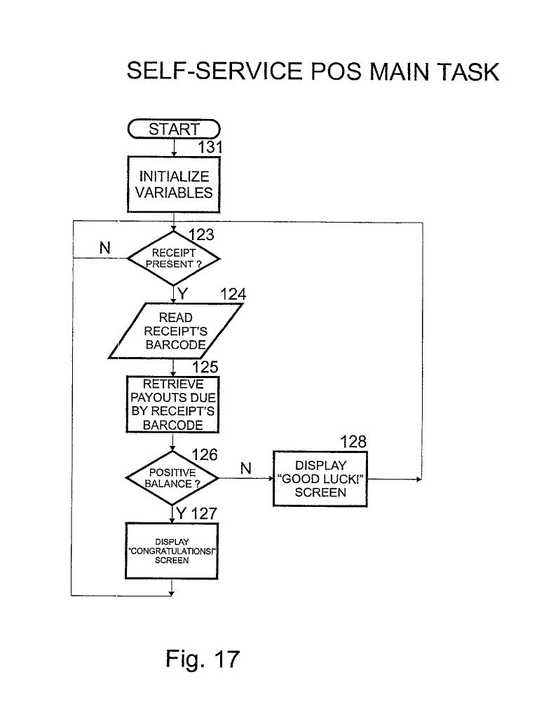

The operation of self-service POS terminal 8 is very similar to the operation of the cashier POS terminal 7 except that the main purpose of the self-service terminal 8 is to permit players to check the status of their sales receipts 17 rather than making payments. Following initialization of variables in step “INITIALIZE VARIABLES” 131, the self-service POS terminal 8 main task illustrated in FIG. 17 waits in the tight loop around step “RECEIPT PRESENT?” 123 until a sales receipt 17 is detected by barcode reader 14. The barcode reader 14 reads a sales receipt 17 in step “READ RECEIPT'S BARCODE” 124 and retrieves balance due to the sales receipt 17 from the database 38 in step “RETRIEVE PAYOUTS DUE BY RECEIPT'S BARCODE” 125. The task checks the value of the retrieved balance in step “POSITIVE BALANCE” 126. If the balance is zero, the program causes a display of a “Good Luck!” screen of the type shown in FIG. 7 by performing step “DISPLAY “GOOD LUCK!”SCREEN” 128. If the balance is positive, the program causes displaying of a “Congratulations!” screen of the type shown in FIG. 6 by performing step “DISPLAY “CONGRATULATIONS!”SCREEN” 127. Thereafter, the program loops back to the beginning.

It should be understood by a person skilled in the art that the operation of the self-service POS terminal 8 can be expanded to perform any and all functions of cashier POS terminal 7, including reading a player card 18, selecting a session and number of packs, displaying amount due, accepting payments through bill acceptor 19, printing and archiving sales receipts 17 on receipt printer 15, and paying out prizes through bill dispenser 21 upon successful matching of barcode 26 on sales receipt 17 with player-tracking card 18.

Although a specific embodiment of the present invention was described above, it should be understood by a person skilled in the art that the invention may be embodied otherwise without departing from its principles. In particular, although the TV monitors 11 are utilized in the system of FIG. 1, other displays, including LCD or LED displays, are suitable for the purpose of informing the players about the current status of the game. Although an Ethernet network is a part of the system of FIG. 1, other types of Local Area Networks (“LAN”), including an IEEE-485 network may be utilized. Moreover, the network 6 does not have to be wire or fiber-optic based, it may be totally wireless by employing radio and/or infrared communication techniques similar to the communication channel 23 between the caller computer and the portable player unit 22. The network may even be at least partially an Internet network. In particular, players may check status of their sales receipt utilizing their home computer acting as a self-service point of sale terminal.

Importantly, a number of elements enumerated in FIG. 1 may be omitted or combined together while the remaining system still embodies the main principles of invention. For example, the barcode reader 14 and bill acceptor 19 may be combined in one device. Moreover, a barcode reader 14 may serve as a player-tracking device in case player-tracking cards 18 are barcoded. In addition, the magnetic card reader 16, receipt printer 15, bill acceptor 19 and bill dispenser 21 may be omitted in the self-service terminal 8, while it can be used by players as a tool to check the status of their sales receipts 17 without having to bother cashiers. Similarly, the barcode reader 14 may not be necessary and instead, the player may enter the sales receipt identification number 24 via the touch screen 12 or the keyboard 13 and, in fact, the keyboard 13 can be substituted for the touch screen 12 completely. Moreover, the entire self-service POS terminal 8 may not be necessary because its functions can be implemented on the cashier's point of sale terminal 7. Similarly, the entire cashier point-of-sale terminal 7 may be omitted and the self-service point-of-sale terminal 8 may be utilized instead since the self-service point of sale terminal 8 can accept payment through bill acceptor 19 and dispense the winnings through bill dispenser 21. Moreover, ultimately all terminals of FIG. 1 including bingo caller terminal 1, cashier POS terminal 7 and self-service POS terminal 8 can be combined together in just one terminal executing the functions of all terminals listed above. The portable player units 22 are also not a necessary element of the invention even though they do facilitate realtime presentation of the status of bingo cards purchased by the player. Similarly, the TV monitors 11 may be omitted and the information presented on the TV screens can be displayed on the screens of the point-of-sale terminals 7 and 8.

It should also be understood that bingo caller terminal is capable of producing a broad variety of accounting reports and game logs 40 printed on the log printer 5. For example, a report listing all unpaid winnings 37 may be retrieved from the database 38 and spooled out to printer 5. Similarly, a report listing all paid up winnings may be retrieved from the database 38 and printed out on printer 5. Virtually any data stored on the database 5 can be printed by printer 5.

Although a SQL-type database was recommended for use in the system of FIG. 1, other databases, including hierarchical databases are suitable for the purpose of archiving and retrieving pertinent data. Even though the flow charts of FIGS. 9 through 13 were described above and recommended for implementation in the system of FIG. 1, the specific software package suitable for embodying the principles of the invention may be designed in a myriad of alternative ways, in a broad variety of computer languages and may be executed in multiple operating system environments, including Unix®, Windows®, PCDOS®, etc. The specific hardware selected for the implementation of the system of FIG. 1 and the like is not limited to personal computers with associated peripherals as virtually any general-purpose computer is applicable, including minicomputers and mainframe computers. The designs of the screens of FIGS. 4 through 8 are only simplified examples. A broad variety of multimedia and animation techniques may be employed to make screens more attractive as long as the information presented on the screens adequately reflects the main principles of the invention.

The sales receipts illustrated in FIGS. 2 and 3 may vary broadly in form and content while still providing adequate information necessary to identify the bingo cards attributable to each such sales receipt. It is even conceivable to have one or a few “special” bingo cards explicitly imprinted on a sales receipt (e.g., a “bonanza”bingo card). Also, at least some bingo cards, including best bingo cards and winning bingo cards, can be explicitly shown on TV monitors 11. Moreover, actual premanufactured paper bingo cards may be supplied along with receipts 17. Although paper bingo cards are not necessary and even undesirable in a casino environment, they may be useful initially in a transition period to overcome a natural psychological aversion of bingo players to a “blind and card-less” mode of playing bingo.

In the case of paper bingo cards supplied along with receipts 17, an additional burden has to be placed on players to make sure that the “face” numbers of purchased paper bingo cards match with the identification numbers 33 imprinted on the sales receipt 17. In the alternative, a cashier may be entrusted to make sure that the identification number of the first bingo card 133 expected to be sold to the next customer that is computed in step “COMPUTE AND DISPLAY CARD INDEXES FOR NEW RECEIPT” 56 does match the “face number” of the first bingo card of the next pack of paper bingo cards expected to be sold to the next customer. If they do not match, the cashier will have to manually override the expected identification number of the first bingo card 133 by entering a respective correction through the touch-screen monitor 12 as illustrated in step 132 of FIG. 10. Once the correction is manually entered, the cashier terminal 7 automatically adjusts in step 56 all subsequent card indexes of cards to be sold. Conceptually, the capability to manually override base card number 133 makes receipts 17 unnecessary because paper bingo cards including security means may serve as satisfactory evidence of a legitimate sale. In such a case, instead of leading receipt numbers 17, the TV monitors 11 can show the leading base numbers 133 to inform players which packs are the leading packs of bingo cards.

Although not mentioned specifically above, it is presumed that the cashier terminal 7 is equipped with conventional touch-screen based cash register facilities including, but not limited to, provisions for entering and canceling quantities and passwords, voiding sales receipts, manipulating cash drawer, reconciling and printing accounting reports, printing exception logs, etc.

We claim:

1. A system for playing a game of bingo including:
a data processing means, said data processing means storing a plurality of bingo card patterns and generating statements having informational data thereon and corresponding to one or more of said bingo card patterns;
a printer in communication with said data processing means for printing said generated statements;
means to generate random numbers, said generation means in communication with said data processing means such that said generated random numbers are communicated to said data processing means;
said data processing means determining whether one or more of said bingo card patterns are winning cards by comparing said stored bingo patterns with each of the numbers generated and storing a status of each card as said numbers are generated, said means to generate random numbers being disabled upon determination of one or more winning cards; and
means to notify participants of the status of stored bingo cards corresponding to said generated statements.

2. The system of claim 1 wherein said data processing means is a microprocessor.

3. The system of claim 2 wherein said means to generate random numbers is a random number generator integrated in said microprocessor.

4. The system of claim 1 wherein said means to generate random numbers is a bingo ball hopper.

5. The system of claim 1 wherein said means to notify said participants of the status of their statements is a monitor, viewable by said participants, in communication with said data processing means.

6. The system of claim 5 wherein said monitor displays one or more of the bingo cards closest to achieving bingo.

7. The system of claim 5 wherein said monitor displays a statement identification code corresponding to the best bingo card.

8. The system of claim 5 wherein said monitor displays the numbers needed to be generated for a best bingo card to achieve bingo.

9. The system of claim 1 wherein said data processing means comprises a computer network having one or more point of sale terminals.

10. The system of claim 9 wherein said one or more point of sale terminals includes a magnetic card reader, a barcode reader, a bill acceptor, a printer, a bill dispenser and a keyboard.

11. The system of claim 9 wherein said one or more point of sale terminals includes a smart card reader, a barcode reader, a bill acceptor, a printer, a bill dispenser and a keyboard.

12. The system of claim 9 wherein said one or more point of sale terminals includes a magnetic card reader, a barcode reader, a bill acceptor, a printer, a bill dispenser and a touch screen.

13. The system of claim 9 wherein said one or more point of sale terminals includes a smart card reader, a barcode reader, a bill acceptor, a printer, a bill dispenser and a touch screen.

14. The system of claim 9 wherein said point of sale terminals include a monitor for displaying a current status of at least one statement including a payout value associated therewith.

15. The system of claim 1 wherein, upon determination of one or more winning bingo cards, said data processing means further determines a prize associated therewith.

16. The system of claim 1 including a session of bingo games, said session comprising at least two bingo games in sequence, upon the occurrence of one or more predetermined events, said occurrence enabling said means to generate random numbers.

17. The system of claim 16 wherein the predetermined event is a predetermined time since completion of a previous bingo game.

18. The system of claim 16 wherein the predetermined event is a predetermined time for a start of a new game.

19. The system of claim 16 wherein the predetermined event is a predetermined number of sales of bingo cards for a new game.

20. The system of claim 1 wherein said data processing unit further validates said statements upon presentation by comparing stored informational data corresponding to said statements with said information printed on said statements.

21. The system of claim 20 wherein said information printed on said statements includes an identification code.

22. The system of claim 20 wherein said information printed on said statements includes a verification code.

23. The system of claim 20 wherein said information printed on said statements includes a player tracking number.

24. The system of claim 20 wherein said information printed on said statements includes a player name.

25. The system of claim 20 wherein at least portions of said information printed on said statements is in the form of a barcode.

26. The system of claim 10 wherein said point of sale terminals include a data processing means that generates and prints one or more statements each including an identification and verification number; and
said data processing means displaying on a monitor an outcome corresponding to said statement upon first inputting said identification number, said data processing means validating said statement upon second inputting the verification number.

27. The system of claim 1 further including a cashier terminal in communication with said data processing unit, said cashier terminal including a monitor for displaying an outcome corresponding to said printed statements.

28. The system of claim 27 wherein said data processing means scans identification and verification codes printed on said statements to retrieve the results of the bingo cards corresponding to said statements.

29. The system of claim 28 wherein an operator may override the data processing means and manually enter the identification and verification codes.

30. A computer implemented method of playing a game of bingo including:
storing a plurality of bingo card patterns and generating one or more statements corresponding to said bingo card patterns;
printing said generated statements;
generating random numbers;
determining whether one or more of said bingo card patterns are winning cards by comparing said stored bingo patterns with each of the numbers generated and storing a status of each card as said numbers are generated;
disabling generation of random numbers upon determining one or more winning cards; and
notifying participants of the status of stored bingo cards corresponding to said generated statements.

31. The method of claim 30 wherein generating random numbers comprises a random number generator integrated in a microprocessor.

32. The method of claim 30 wherein generating random numbers comprises a bingo ball hopper.

33. The method of claim 30 wherein notifying said participants of the status of their statements comprises a monitor, viewable by participants, in communication with said computer.

34. The method of claim 33 wherein said monitor displays one or more of the bingo cards closest to achieving bingo.

35. The method of claim 33 wherein said monitor displays a statement identification code corresponding to the best bingo card.

36. The method of claim 33 wherein said monitor displays the numbers needed to be generated for a best bingo card to achieve bingo.

37. The method of claim 30 further comprising a computer network having one or more point of sale terminals.

38. The method of claim 37 wherein said point of sale terminals include a monitor for displaying a current status of at least one statement including a payout value associated therewith.

39. The method of claim 30 further including determining a prize associated with the determination of one or more winning bingo cards.

40. The method of claim 30 further comprising a session of bingo games, said session comprising at least two bingo games in sequence, upon the occurrence of one or more predetermined events, said occurrence enabling said generating of random numbers.

41. The method of claim 40 wherein the predetermined event is a predetermined time since completion of a previous bingo game.

42. The method of claim 40 wherein the predetermined event is a predetermined time for a start of a new game.

43. The method of claim 40 wherein the predetermined event is a predetermined number of sales of bingo cards for a new game.

44. The method of claim 30 further comprising validating said statements upon presentation by comparing stored informational data corresponding to said statements with said information printed on said statements.

45. The method of claim 44 wherein said information printed on said statements includes an identification code.

46. The method of claim 44 wherein said information printed on said statements includes a verification code.

47. The method of claim 44 wherein said information printed on said statements includes a player tracking number.

48. The method of claim 44 wherein said information printed on said statements includes a player name.

49. The method of claim 44 wherein at least portions of said information printed on said statements is in the form of a barcode.

50. The method of claim 37 wherein said point of sale terminals generate and print one or more statements each including an identification and verification number;
said terminals displaying on a monitor an outcome corresponding to said statement upon first inputting said identification number and validating said statement upon second inputting the verification number.

51. The method of claim 30 further comprises displaying an outcome corresponding to said printed statements.

52. The method of claim 51 wherein said displaying an outcome corresponding to said printed statements comprises scanning identification and verification codes printed on said statements to retrieve the results of the bingo cards corresponding to said statements.

53. The method of claim 52 wherein said scanning operation is overridden and the identification and verification codes are inputted manually.
